(19) United States
(12) Patent Application Publication
(10) Pub. No.: US 2007/0152960 A1
(43) Pub. Date: Jul. 5, 2007

(54) Airbag-form key

(76) Inventor: Hsien Ta Huang, Taoyuan Hsien (TW)

Correspondence Address: HSIEN TA HUANG;235 Chung-Ho, Box 8-24, Taipei, TW

(21) Appl. No.: 11/321,951

(22) Filed: Dec. 30, 2005

(51) Int. Cl. G09G 5/00

(52) U.S. Cl. 345/156

(57) ABSTRACT

An airbag-form key comprises a pressable unit; a top of the pressable unit being the soft rubber body; an internal of the pressable unit having the hollow airbag; a wall of the hollow airbag having a recess; a cross section of the recess having a T shape; a bottom of the recess being formed with a buckling ring which has an approximate J shape cross section; an axial touch unit assembled to a bottom of the pressable unit; a top of the axial touch unit being formed as a buckling ring; a cylindrical wall being extended downwards from the buckling ring; a notch being formed at a lower side of the cylindrical wall; a seat assembled at a lower periphery of the axial touch unit; a top of the seat having a stop ring; and a top inner side of the seat being formed as a tightening surface.

### FIELD OF THE INVENTION

The present invention relates to keys, and in particular to an airbag-form key having a top made of soft rubber body, and an interior of the soft rubber body having a hollow airbag. The structure is firmly and concrete. Thereby when the airbag-form key is pressed by a finger, the soft rubber body and the hollow airbag provide a soft feeling.

### BACKGROUND OF THE INVENTION

Almost all electronic devices are installed with keys, specifically for joysticks of game machines

Referring to FIG. 1A, a conventional key 9 is illustrated. The key 9 is installed between a casing 9. The key moves downwards as a finger presses upon it. Conventionally, the key has a solid structure and is hard. However in use, the joystick is used for a longer time, the comfort of the key is a main concern in the design of the key, but the hard key 9 will make the finger feel ache, even get diseases, or deform. Thereby the prior art hard key 9 is not a preferred one.

### SUMMARY OF THE INVENTION

Accordingly, the primary object of the present invention is to provide an airbag-form key having a top made of soft rubber body, and an interior of the soft rubber body having a hollow airbag. The structure is firmly and concrete. Thereby when the airbag-form key is pressed by a finger, the soft rubber body and the hollow airbag provide a soft feeling.

To achieve above objects, the present invention provides an airbag-form key. The airbag-form key comprises a pressable unit; a top of the pressable unit being the soft rubber body; an internal of the pressable unit having the hollow airbag; a wall of the hollow airbag having a recess; a cross section of the recess having a T shape; a bottom of the recess being formed with a buckling ring which has an approximate J shape; an axial touch unit assembled to a bottom of the pressable unit; a top of the axial touch unit being formed as a buckling ring; a cylindrical wall being extended downwards from the buckling ring; a notch being formed at a lower side of the cylindrical wall; a seat assembled at a lower periphery of the axial touch unit; and a top of the seat having a stop ring; a top inner side of the seat being formed as a tightening surface.

The various objects and advantages of the present invention will be more readily understood from the following detailed description when read in conjunction with the appended drawing.

### BRIEF DESCRIPTION OF THE DRAWINGS

FIG. 1A is a cross sectional view about a prior art solid key.

FIG. 1B is a cross sectional view about the prior art solid key.

FIG. 2A is a cross sectional view about the airbag-form key of the present invention.

FIG. 2B shows the operation of the airbag-form key of the present invention.

FIG. 2C shows another operation of the airbag-form key of the present invention.

FIG. 3 is a perspective view of another embodiment of the airbag-form key of the present invention.

FIG. 4 is an exploded view of another embodiment of the airbag-form key of the present invention.

FIG. 5 is a partial cross sectional view of another embodiment of the airbag-form key of the present invention.

FIG. 6 is an assembled cross sectional view of another embodiment of the airbag-form key of the present invention.

FIG. 7 is a perspective view of the present invention.

FIG. 8 is a cross sectional view about the single control key of the present invention.

FIG. 9 is a schematic view about the application of the single control key of the present invention.

FIG. 10 is an upper view of the compound key of the present invention.

FIG. 11 is a cross sectional view along line A-A of FIG. 4.

FIG. 12 is a cross sectional view about the operation of the compound key of the present invention.

FIG. 13 is a plane schematic view about the touch plate of the present invention.

FIG. 14 is a schematic view about the contact between the compound key and a circuit board.

FIG. 15 is a schematic view about the use of the compound key of the present invention.

FIG. 16 is a schematic view showing that the axial touch rod has blocks at a top thereof.

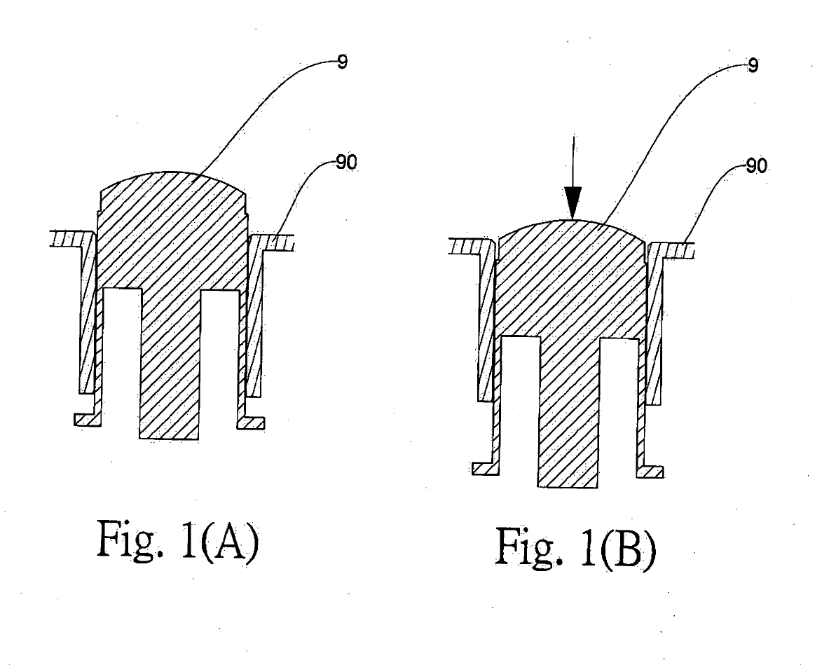

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

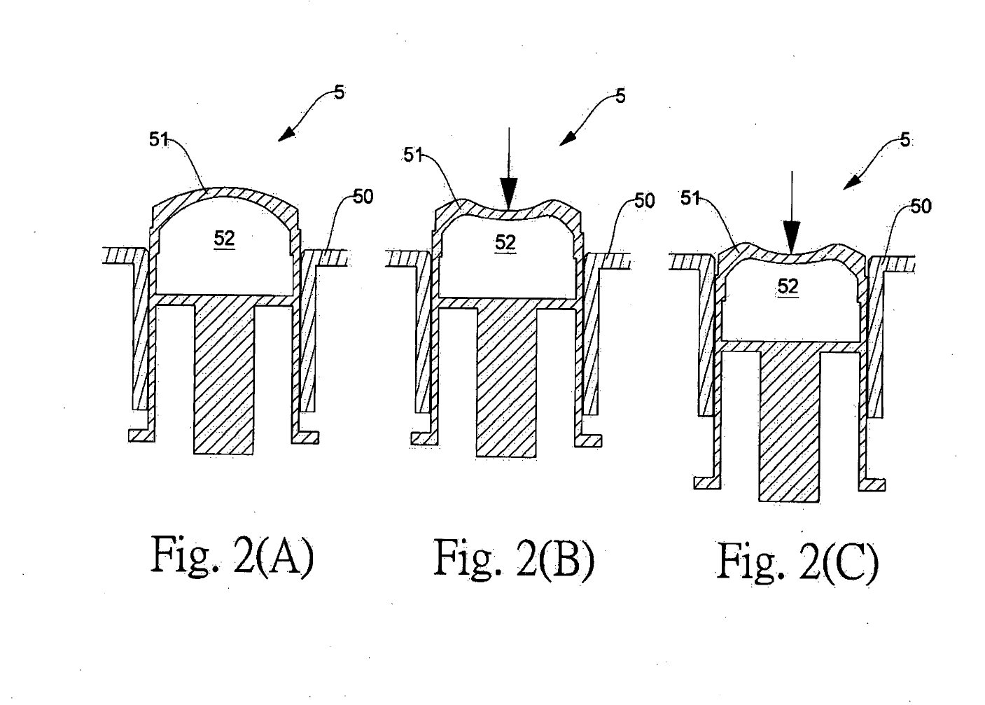

Referring to FIG. 2A, the airbag-form key of the present invention is illustrated. The airbag-form key has the following elements.

A supporting frame 50 is included.

A casing 51 is installed in the supporting frame 50. The casing 51 has a hollow airbag 52 therein. A top of the hollow airbag 52 is a soft rubber body 51. A center of the soft rubber body 51 is thinner than other portions. When the top of the soft rubber body 51 is pressed by a finger, the center of the soft rubber body 51 will collapse, see FIG. 2B. When the pressure is retained, the whole airbag-form key 5 will move downwards, as shown in FIG. 2C so as to complete the pressing operation. When the airbag-form key 5 of the present invention is pressed, by a finger, the airbag-form key 5 will provide a preferred softness and buffer effect so that the user will not feel uneasy.

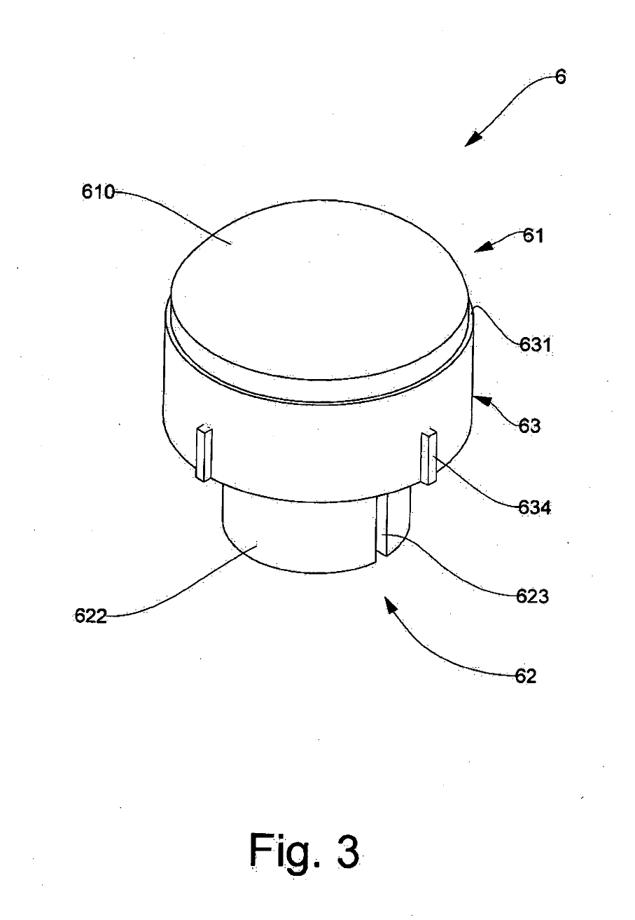

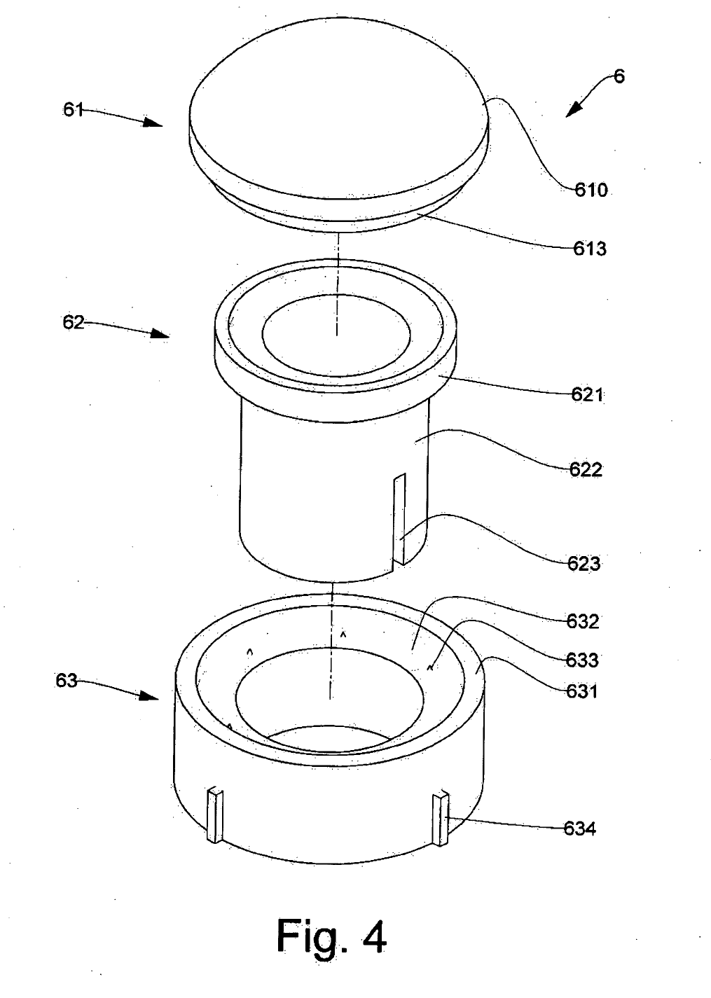

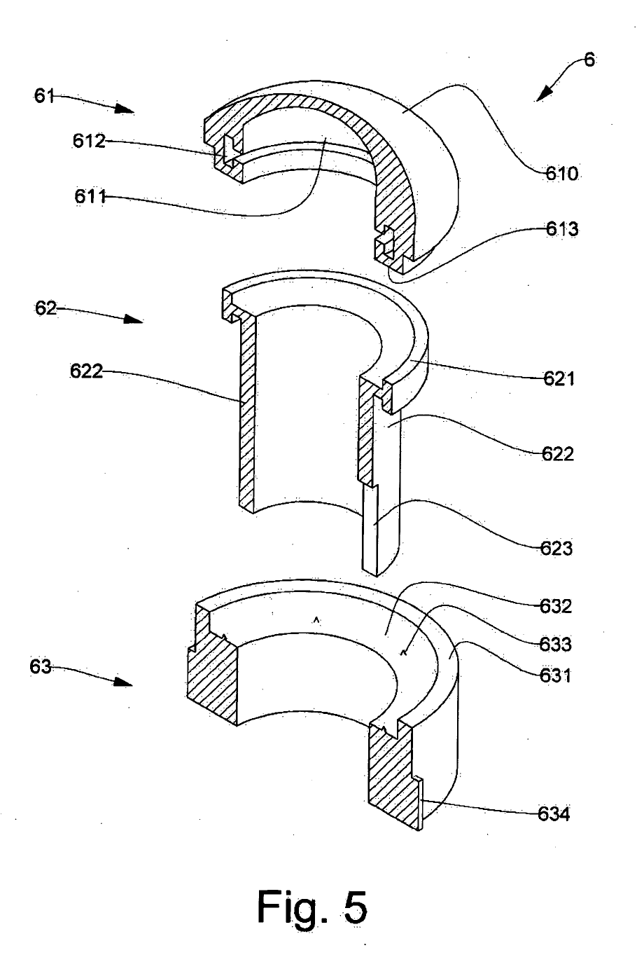

Referring to FIGS. 3, 4, and 5, another embodiment of the present invention is illustrated. The airbag-form key 6 has the following elements.

A pressable unit 61 is included. A top of the pressable unit 61 is a soft rubber body 610. An internal of the pressable unit 61 has a hollow airbag 611. A wall of the hollow airbag 611 has a recess 612. A cross section of the recess 612 has a T shape. A bottom of the recess 612 is formed with a buckling ring 613 which has an approximate J shape.

An axial touch unit 62 is assembled to a bottom of the pressable unit 61. A top of the axial touch unit 62 is formed as a buckling ring 621. A cylindrical wall 622 is extended downwards from the buckling ring 621. A notch 623 is formed at a lower side of the cylindrical wall 622.

A seat 63 is assembled at a lower periphery of the axial touch unit 62. A top of the seat 63 has a stop ring 631. A top inner side of the seat 63 is formed as a tightening surface 632. A plurality of projections 633 is formed on the tightening surface 632. A periphery of the seat 63 is formed with two protrusions 634.

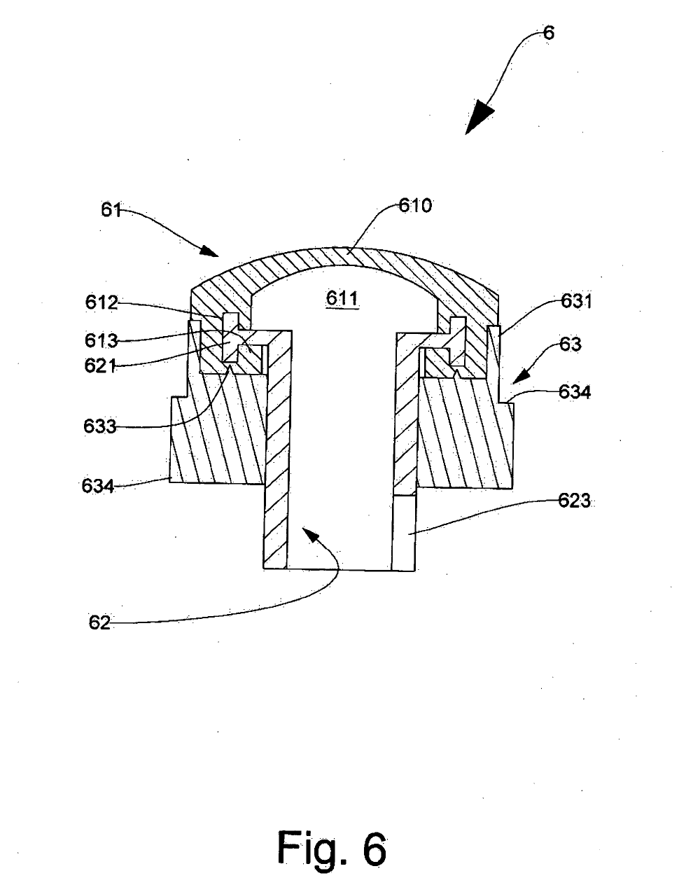

In assembly of the pressable unit 61, the axial touch unit 62, and the seat 63 (referring to FIG. 6), the buckling ring 621 of the axial touch unit 62 is engaged to the recess 612. Then the seat 63 is tightly engaged to the axial touch unit 62 so that a stop ring 631 confines the periphery of the buckling ring 613. The upper end and lower end of the buckling ring 613 are confined by the buckling ring 613 and the tightening surface 632 with the pressures from the projections 633. The structure is firmly and concrete. Thereby when the airbag-form key 6 is pressed by a finger, the soft rubber body 610 and the hollow airbag 611 provide a soft feeling.

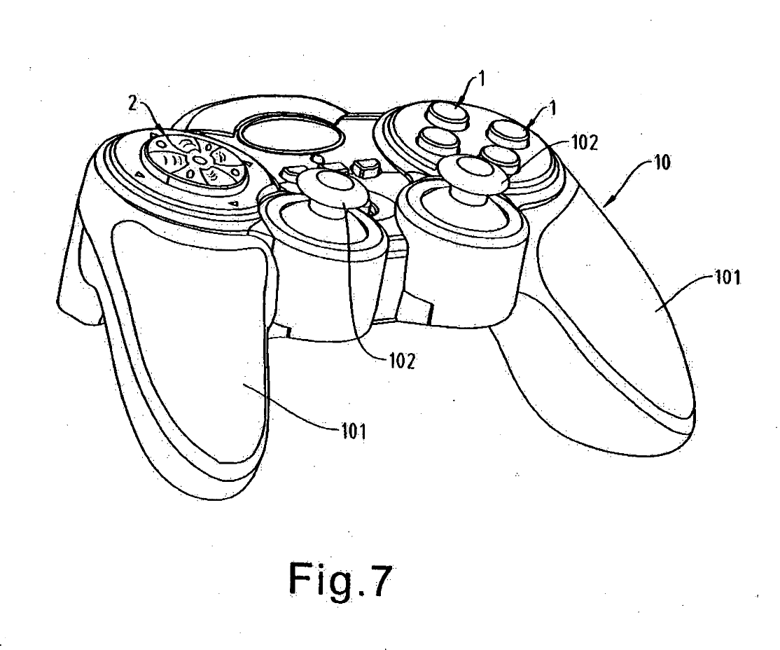

Referring to FIG. 7, an application of the present invention to a hand holding joystick is illustrated. In this embodiment, the hand holding joystick body 10 has a handle 101, a joystick 102, a plurality of single control keys 1 and a compound key 2.

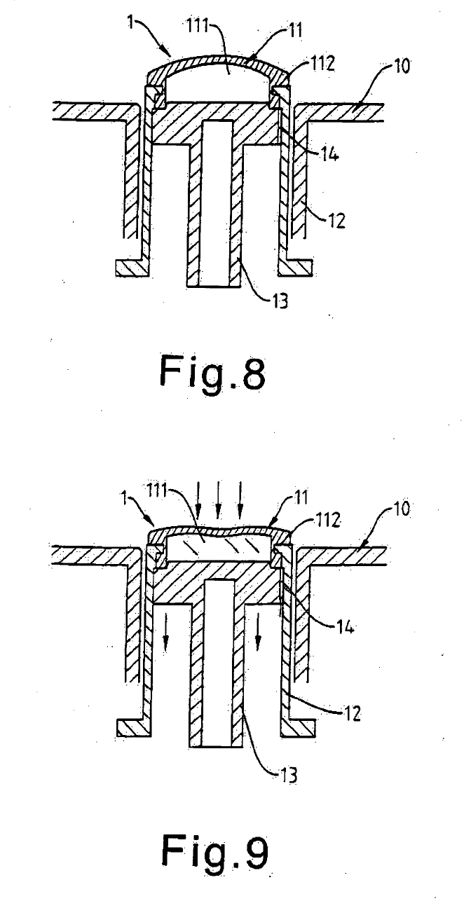

Referring to FIGS. 8 and 9, the main structure of the single control key 1 has a pressable airbag 11, an embedding object 12 and an axial touch rod 13. The pressable airbag 11 is elastic and is formed by a cambered convex soft rubber with a hollow interior so as to form a hollow air chamber 111. A periphery of the pressable airbag 11 is formed with an embedding groove 112 for embedding the embedding object 12. An interior of the pressable airbag 11 and the axial touch rod 13 is formed as a stepped surface for tightly engaging the axial touch rod 13. When the pressable airbag 11 is pressed downwards, the soft rubber material will provide a preferred touching feeling and softness. Moreover, times of collisions are reduced. Furthermore, when the pressable airbag 11 is pressed downwards, it will collapse slightly. An air gap 14 is formed between the axial touch rod 13 and the embedding object 12. Furthermore, the pressable airbag 11 will drain a part of air therein. Thereby air in the hollow air chamber 111 is transferred when it is pressed and released.

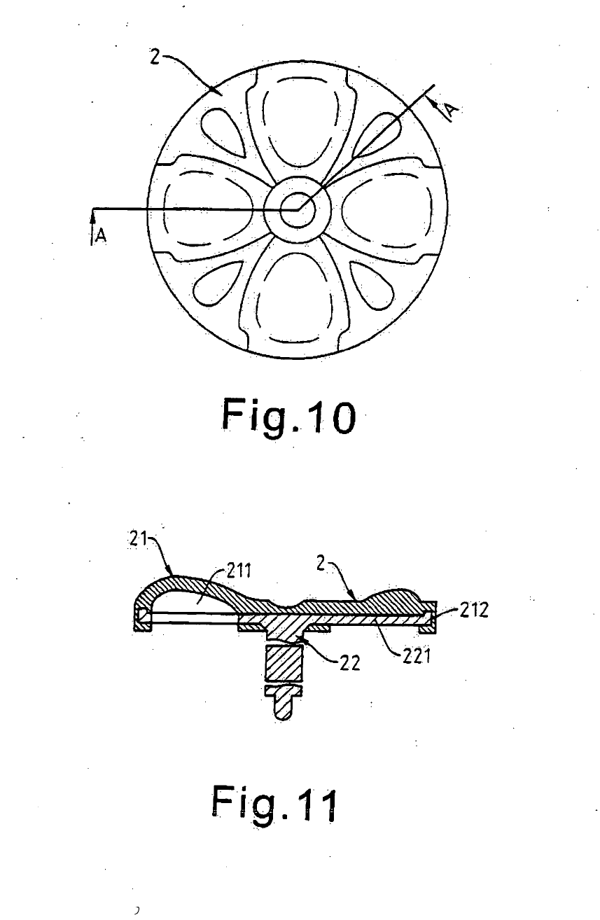

Referring to FIGS. 7, 10 and 11, a compound key 2 is installed at one side of the hand holding joystick body 10. The compound key 2 has many applications. The compound key 2 is elastic and has a plurality of pressable airbags 21 each having a cambered convex surface and made of soft rubber material. A protrusion portion of each pressable airbag 21 is formed with a hollow air chamber 211. The user can press the compound key 2 at different positions. An axial guide 21 is installed at a lower interior of each pressable airbag 21. The axial guide 21 has a plate body 221. The lower interior of the pressable airbag 21 has an embedding groove 212. The plate body 221 is engaged to the embedding groove 212 so that the axial guide 21 is engaged to the pressable airbag 21.

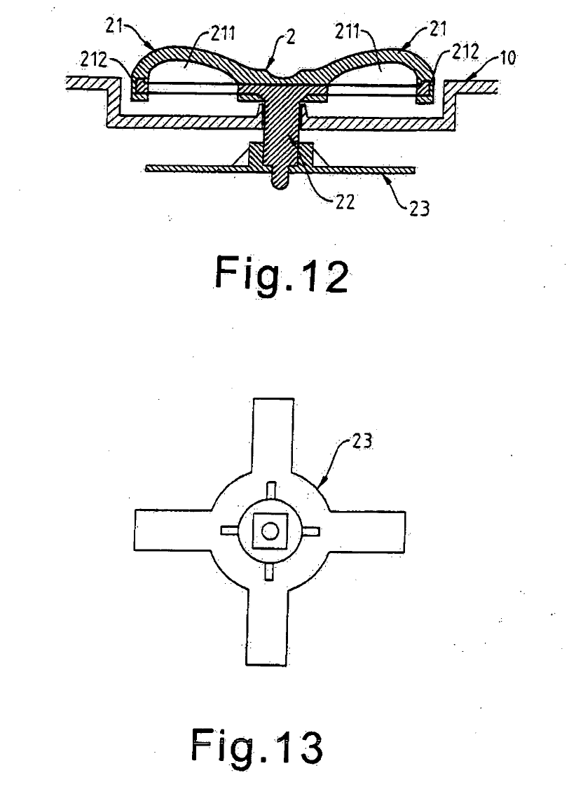

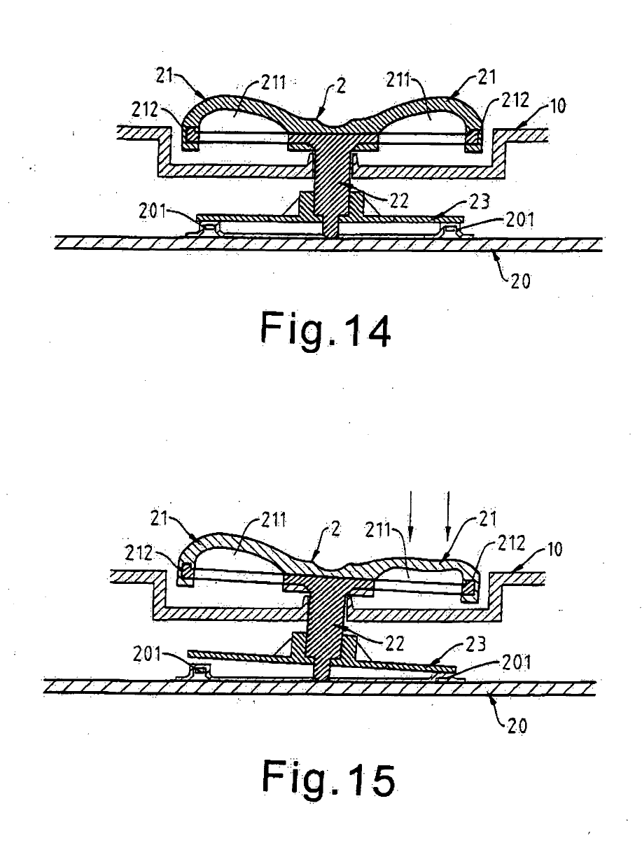

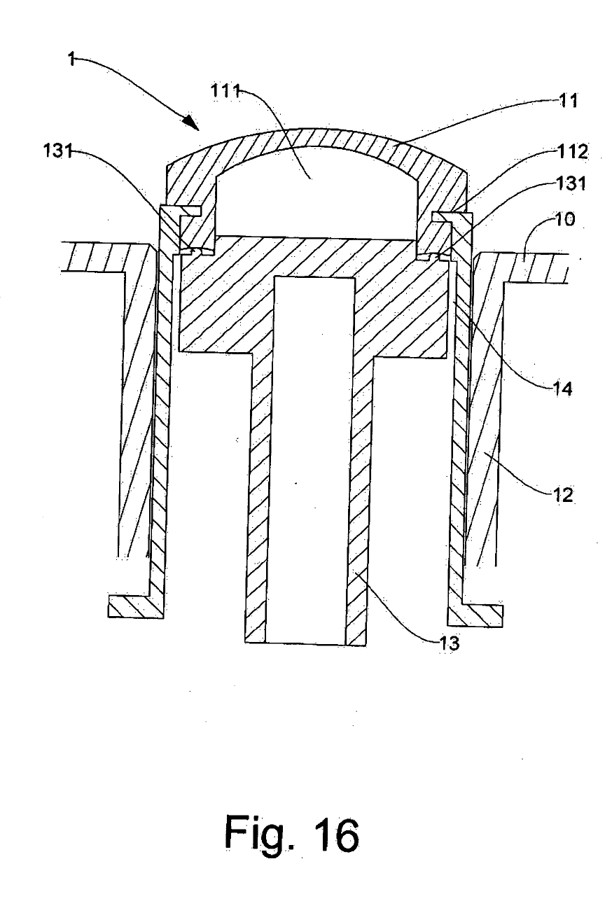

Referring to FIGS. 11 to 15, the compound key 2 is illustrated. The axial guide 22 is non-round cylinder for positioning a touch plate 23. When one of the pressable airbags 11 is pressed, since the axial guide 2 drives the touch plate 23 (referring to FIG. 15), a conductive soft rubber 201 on the circuit board 20 will be induced.

Referring to FIG. 16, another embodiment of the present invention is illustrated. A top of the axial touch rod 13 has a plurality of blocks 131 which resist against a bottom of the pressable airbag 11. Since the embedding groove 112 of the pressable airbag 11 presses the embedding object 12. By the blocks 131, the embedding groove 112 will effectively clamp the embedding object 12.

The present invention can be used widely. Other than using in the hand holding joystick, keyboards and remote controllers are suitable to use with the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An airbag-form key having a top made of soft rubber body, and an interior of the soft rubber body having a hollow airbag.

2. The airbag-form key as claimed in claim 1, wherein the airbag-form key is an integral structure.

3. The airbag-form key as claimed in claim 1, further comprising:
a pressable unit; a top of the pressable unit being the soft rubber body; an internal of the pressable unit having the hollow airbag; a wall of the hollow airbag having a recess; a cross section of the recess having a T shape; a bottom of the recess being formed with a buckling ring which has an approximate J shape cross section;
an axial touch unit assembled to a bottom of the pressable unit; a top of the axial touch unit being formed as a buckling ring; a cylindrical wall being extended downwards from the buckling ring; a notch being formed at a lower side of the cylindrical wall;
a seat assembled at a lower periphery of the axial touch unit; a top of the seat having a stop ring; a top inner side of the seat being formed as a tightening surface; a plurality of projections being formed on the tightening surface; a periphery of the seat being formed with protrusions.

4. A airbag-form key; the airbag-form key being a single control key having a pressable airbag, an embedding object and an axial touch rod; wherein the pressable airbag is elastic and is formed by a cambered convex soft rubber with a hollow interior so as to form a hollow air chamber; a periphery of the pressable airbag is formed with an embedding groove for embedding the embedding object; an interiors of the pressable airbag and the axial touch rod are formed as a stepped surface for tightly engaging the axial touch rod.

5. The airbag-form key as claimed in claim 1, wherein a top of the axial touch rod has a plurality of blocks which resist against a bottom of the pressable airbag; since the embedding groove of the pressable airbag presses the embedding object; by the blocks, the embedding groove will effectively clamp the embedding object.

6. A airbag-form key; the airbag-form key being a compound key which is elastic and has a plurality of pressable airbags each having a cambered convex surface and made of soft rubber material; a protrusion portion of each pressable airbag being formed with a hollow air chamber; an axial guide being installed at a lower interior of each pressable airbag; the axial guide having a plate body; the lower interior of the pressable airbag having an embedding groove; the plate body being engaged to the embedding groove so that the axial guide is engaged to the pressable airbag.

7. The airbag-form key as claimed in claim 6, wherein each pressable airbag is a key.

8. The airbag-form key as claimed in claim 1, wherein the airbag-form key is applied to one of a joystick, a remote controller, and a keyboard.

9. The airbag-form key as claimed in claim 3, wherein the airbag-form key is applied to one of a joystick, a remote controller, and a keyboard.

10. The airbag-form key as claimed in claim 6, wherein the airbag-form key is applied to one of a joystick, a remote controller, and a keyboard.
